(19) United States
(12) Patent Application Publication
(10) Pub. No.: US 2012/0205364 A1
(43) Pub. Date: Aug. 16, 2012

(54) METHOD FOR HEATING A WORKPIECE AND A CORRESPONDING TOOL

(75) Inventors: Pekka Suominen, Pori (FI); Risto Salo, Rauma (FI)

(73) Assignees: Hollming Oy, Rauma (FI); Prizztech Oy, Pori (FI)

(21) Appl. No.: 13/391,339

(22) PCT Filed: Aug. 20, 2010
(86) PCT No.: PCT/FI10/50661

§ 371 Date: May 4, 2012

(30) Foreign Application Priority Data
Aug. 21, 2009 (FI) 20095863

(51) Int. Cl. H05B 6/02

(52) U.S. Cl. 219/600

(57) ABSTRACT

A method and a corresponding tool for heating a metallic workpiece. In the method, the metallic piece is heated in a machine tool by attaching thereto an induction heating tool comprising a permanent magnet structure and by rotating and/or moving the metallic piece to be heated and the induction heating tool relative to each other at a suitable distance. In this case, heating eddy currents are induced in the piece, wherein the energy needed for heating is obtained from the motor of the machine tool.

### FIELD OF THE INVENTION

The invention relates to a method defined in the preamble of claim 1 and to an induction heating tool according to the preamble of claim 7.

### BACKGROUND OF THE INVENTION

Induction heating is based on a changing magnetic field which induces, in a piece to be heated, eddy currents which, in turn, heat the piece. Conventionally, the changing magnetic field has been provided by an electromagnet surrounding the piece to be heated and coupled to an alternating-current source at a suitable frequency.

However, the changing magnetic field needed for induction heating can also be provided by mechanical movement, such that the intensity of the magnetic field is invariable. In this case, predominantly the direction, but not the intensity, of the magnetic field vector is changed. If a suitable permanent magnet structure is rotated near a conductive piece, the piece “sees” the changing magnetic field, and eddy currents are induced therein, heating the piece intensively.

In the mechanical engineering industry, parts which must be treated with heat, such as induction hardened, are often manufactured. For heat treatment, the piece is detached from the machine tool, such as a milling machine or a lathe, and the heat treatment is performed elsewhere. However, the needed induction heaters are quite expensive, so, in general, the heat treatment service is bought from a subcontractor, i.e. the workpiece is packed and transported, even for long distances, for the treatment.

Generally, not the entire workpiece, but only a part of it, is hardened. As an example can be mentioned cogwheels where the teeth, and possibly only specific areas thereof, are hardened. The hardening often takes place in a specific step of the machining, i.e., after hardening, the workpiece has to be accurately repositioned in the machine tool. Therefore, hardening causes many separate working steps to the workpiece, interruptions in the machining, and delays, which, naturally, add to the manufacturing costs and the time of manufacturing of the piece.

### OBJECTIVE OF THE INVENTION

An objective of the invention is to eliminate the drawbacks of the prior art referred to above. Especially, an objective of the invention is to disclose a new machining method and a tool to be used in the method by which hardening can be performed in connection with the machining of the workpiece without detaching the piece from the machine tool.

### SUMMARY OF THE INVENTION

The invention relates to a method for heating, such as for example hardening, a metallic workpiece. According to the invention, the metallic piece is heated in a machine tool by attaching thereto an induction heating tool comprising a permanent magnet structure and by rotating and/or moving the metallic piece to be heated and the induction heating tool relative to each other at a suitable distance. As a consequence, heating eddy currents are induced in the piece, wherein the energy needed for heating is solely obtained from the motor of the machine tool. This way, no separate induction heater power sources are needed. Also, the power adjustment is very simple in the method according to the invention. It is effected just by adjusting the rotation speed or the mutual distance of the pieces which rotate or move relative to each other.

In the method, a machining center or a reaming machine can be used as the machine tool, in which case the induction heating tool is rotated on the mandrel of the machine tool in the vicinity of the area to be heated in the piece. Also, a lathe can be used as the machine tool, in which case at least the piece to be heated is rotated. Furthermore, in one embodiment, the machine tool used is a miller or a drilling machine where the induction heating tool is rotated on the mandrel in the vicinity of the area to be heated in the piece.

Preferably in the invention, the power used for heating the piece is measured from the rotating power of the motor of the machine tool reduced by the idling power of the motor. This way, the heating power or the temperature reached by the piece does not have to be measured separately, but the correct and precise heating of the workpiece is managed purely by measuring the motor power.

It is even possible not to perform a separate working step of heating the piece; instead, the metallic piece is heated by the same machine tool and in the same operation with chip removal.

Furthermore, the invention relates to an induction heating tool for heating, such as hardening, a metallic piece or a part of it in a machine tool. According to the invention, the tool includes a mandrel for attaching the induction heating tool to the machine tool and a permanent magnet attached to the mandrel, wherein the energy of the heating eddy currents induced in the piece is obtained from the motor of the machine tool.

Preferably, in connection with the permanent magnet there is provided a structure made of magnetic material and shaped in a manner required by the shapes of the workpiece and the optimal transfer of heating power. In other words, it is preferably shaped on the external surface so as to correspond to the shape of the surface to be heated, such that the shape of the magnets encompasses simple basic forms. The structure made of magnetic material mainly comprises iron or other suitable metal or alloy.

The temperatures used for hardening the metallic piece are in general on the order of 900° C. At the same time, the magnetic properties of the permanent magnet material do not stand temperatures of more than 200° C. Therefore, preferably either the magnet or the iron parts of the tool or both of them are provided with suitable cooling shapes, such as fins, wings or equivalent channels. These enable cooling flows which may be air, gas or liquid flows to be led to the tool or around it. Another possibility is an embodiment where the permanent magnet piece of the tool is encapsulated in a weakly heat conductive casing. However, the casing is made of a material which does not substantially weaken the rotating magnetic field in the piece to be hardened. For example suitable ceramic materials may be considered as this kind of a material.

Important advantages are achieved by the heating method and the tool according to the invention, compared to the prior art. The invention provides simply and quickly for heating, hardening or other heat treatment of a metallic workpiece, partially or entirely, in connection with the machining of the piece. A separate source of energy for heating is not needed, because the needed energy is obtained from the machine tool's own rotating motor. This way, by the invention, important savings are achieved both in the device costs and in the treatment steps and the treatment times.

### LIST OF FIGURES

In the following, the invention will be described in detail with reference to the accompanying drawings, in which

FIG. 1 presents one tool according to the invention,

FIG. 2 presents a second tool according to the invention,

FIG. 3 presents a third tool according to the invention,

FIG. 4 presents the use of the tool of FIG. 2,

FIG. 5 schematically presents the numbers of magnets in the tool,

FIG. 6 schematically presents one tool according to the invention,

FIG. 7 schematically presents one other tool according to the invention,

FIG. 8 schematically presents heating of a plane by the tool according to the invention,

FIG. 9 schematically presents another embodiment for heating a plane and

FIG. 10 presents direction of the magnetic field in the tool according to the invention.

### DETAILED DESCRIPTION OF THE INVENTION

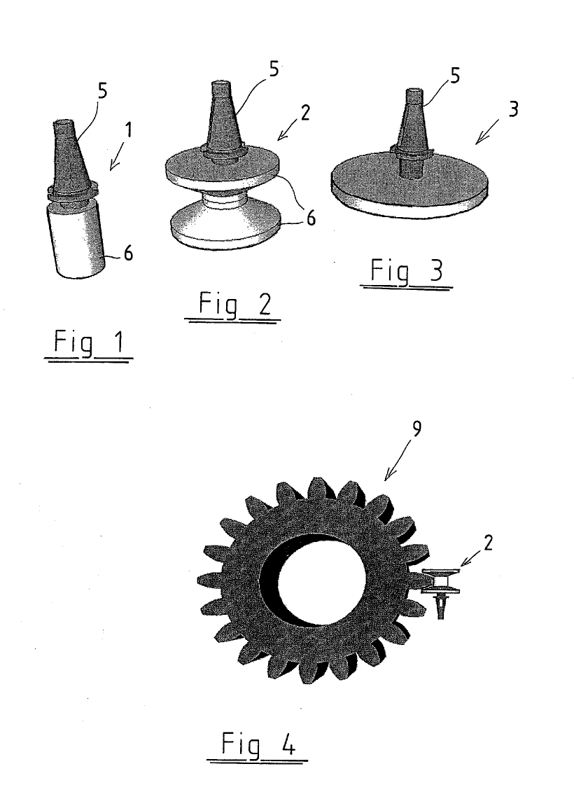

As presented by FIG. 1, the tool 1 according to the invention includes a mandrel 5 by which it can be attached to a machine tool using it, such as a milling machine or a lathe. Attached to the mandrel is a cylindrical permanent magnet 6.

In a corresponding embodiment of FIG. 2, the tool 2 includes, attached to the mandrel 5, two round and disc-shaped magnets 6 or metal sheets provided with magnets. The sheets are spaced at a suitable distance from each other, so that a suitably sized opening remains between them for a metallic piece to be hardened or for a part of a metallic piece to be hardened.

FIG. 3 shows a third embodiment where the tool 3 only includes, attached to the mandrel 5, one round sheet 6 having magnetic properties. All three tools are used in an analogous manner, i.e. the rotating tool is placed as near as possible to the metallic piece to be hardened or heated in another manner, yet not in contact with it. This way, the rotating magnet induces in the piece eddy currents which heat the piece intensively. The energy used for rotating the magnet is obtained from the motor of the machine tool rotating it, and it is transferred almost entirely as heat to the metallic piece.

FIG. 4 illustrates the use of the tool of FIG. 2 in the hardening of a tooth of a cogwheel 9. In the tool 2, the two magnetic round sheets are spaced at a distance from each other equal to the thickness of the tooth, and the shape of their inner surfaces is, corresponding to the tooth, a little beveled, so that the tool can be placed at a precise short distance from the surface of the tooth. By rotating the tool and moving it in the lengthwise direction of the tooth from one edge to another, the tooth can easily and quickly be heated to a desired hardening heat. The cogwheel can this way be hardened by single attachment of the piece in connection with the machining thereof. Furthermore, the heating power can easily be adjusted by changing the rotation speed of the magnet or the distance between the magnet and the workpiece.

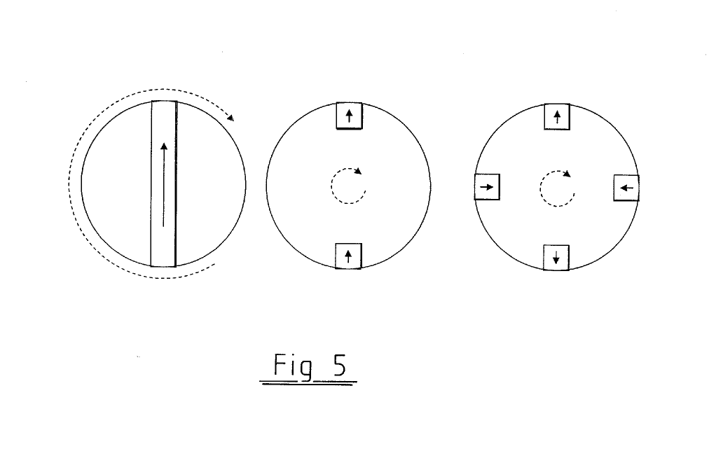

As can be seen from the schematic presentations of FIG. 5, one or more permanent magnets can be used in the tools, so that, as the tools rotate, the piece to be heated which is stationary outside of them sees the changing magnetic field.

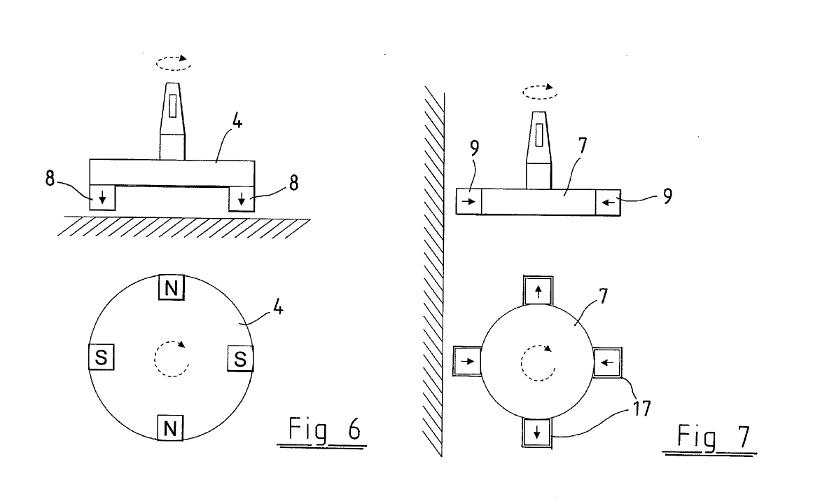

FIGS. 6 and 7 present tools according to the invention, showing that the permanent magnets can be magnetized in any direction such that an intensive magnetic field is formed on the outside of the tool. In FIG. 6, in the tool, magnets 8 are located on the plane surface of the round sheet 4, by the exact outer edge thereof, i.e. the magnetization direction is axial in the tool. In FIG. 7, the magnets 9 are located on the outer edge of the round sheet 7, i.e. on the circumference thereof, so that the magnetization direction is radial in the tool. Also drawn in the lower figure in FIG. 7 is an alternative embodiment where the permanent magnets are encapsulated in a weakly heat conductive ceramic casing 17. The casing prevents excessive heating of the magnets, yet does not substantially affect the magnetic properties of the system.

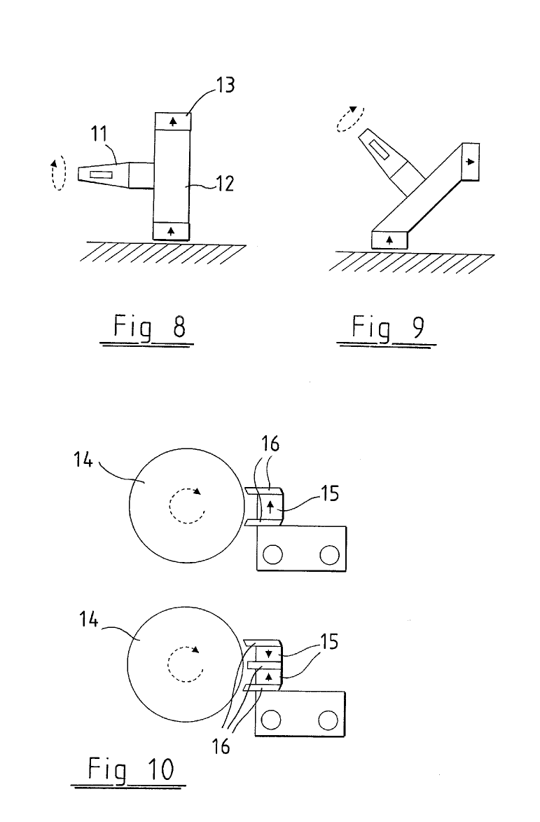

FIG. 8 presents a tool embodiment according to the invention for heating a planar piece in a miller. The tool includes a mandrel 11 to be rotated in the direction of the plane 10 to be heated and provided with a transversal, round and disc-shaped body 12 with magnets 13 provided on the periphery thereof. The nearer to the plane, yet not in contact with it, the tool is rotated, the more intensively the heating eddy currents are induced in the plane.

FIG. 9 presents an embodiment corresponding to FIG. 8 where the axis of the tool is slanted, i.e. at an angle of 45°, relative to the plane to be heated.

FIG. 10 presents useful embodiments of the invention, especially for hardening or heating pieces or parts of pieces in multiple forms. In the embodiments of the figure, the piece to be heated 14 is attached to a lathe and the piece is rotated by the motor of the lathe while the tool is stationary. The tool may contain one or more permanent magnets 15. The magnetic field is shaped and directed by sheets or pieces 16 made of iron or other equivalent material located around or in the middle of the magnet or magnets. By these pieces, the rotating magnetic field can be directed as near as possible to the workpiece or a part thereof, in which case the magnets themselves do not have to be shaped.

The invention is not limited merely to the examples referred to above; instead, many variations are possible within the scope of the inventive idea defined by the claims.

1. A method for heating a metallic workpiece, wherein the metallic piece is heated in a machine tool by attaching to the machine tool an induction heating tool comprising a permanent magnet structure and by rotating and/or moving the metallic piece to be heated and the induction heating tool relative to each other at a suitable distance, in which case heating eddy currents are induced in the piece, wherein the energy needed for heating is obtained from the motor of the machine tool.

2. The method according to claim 1, wherein a machining center or a reaming machine is used as the machine tool, in which case the induction heating tool is rotated on the mandrel of the machine tool in the vicinity of the area to be heated in the piece.

3. The method according to claim 1, wherein a lathe is used as the machine tool, in which case at least the piece to be heated is rotated.

4. The method according to claim 1, wherein the machine tool used is a miller or a drilling machine where the induction heating tool is rotated on the mandrel in the vicinity of the area to be heated in the piece.

5. The method according to claim 1, wherein the power used for heating the piece is measured from the rotating power of the motor of the machine tool reduced by the idling power of the motor.

6. The method according to claim 1, wherein the metallic piece is heated by the same machine tool and in the same step with the chip removal.

7. An induction heating tool for heating a metallic piece or a part thereof in a machine tool, wherein the induction heating tool includes a mandrel for attaching it to the machine tool and a permanent magnet attached to the mandrel, wherein the energy for the heating eddy currents induced in the piece is obtained from the motor of the machine tool.

8. The tool according to claim 7, wherein in connection with the permanent magnet there is a structure made of magnetic material shaped in a manner required by the shapes of the workpiece and the optimal transfer of heating power.

9. The tool according to claim 8, wherein the structure made of magnetic material comprises iron.

10. The tool according to claim 7, wherein the tool includes shapes, fins, wings or equivalent channels for cooling the tool by an air, gas or liquid flow.

11. The tool according to claim 7, wherein the permanent magnet piece of the tool is at least partially encapsulated in a weakly heat conductive casing.
